(19) United States
(12) Patent Application Publication
(10) Pub. No.: US 2006/0106647 A1
(43) Pub. Date: May 18, 2006

(54) Method and apparatus for determining pharmacy order parameters based on patient context data

(76) Inventors: Anthony C. Brummel, Middleton, WI (US); Brian R. Eith, McFarland, WI (US); Jeffrey A. Krueger, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/992,568

(22) Filed: Nov. 18, 2004

(51) Int. Cl. G06F 19/00

(52) U.S. Cl. 705/3

(57) ABSTRACT

A health care information system includes an information database and a pharmacy module. The information database is adapted to store a record for a patient including patient context data. The pharmacy module is adapted to receive a pharmacy order for the patient, retrieve the patient context data from the record in the information database, and determine at least one recommended parameter for the pharmacy order based on the patient context data. A method for determining pharmacy order parameters in a health care information system includes storing a record for a patient including patient context data. A pharmacy order is received for the patient. The patient context data is retrieved from the record in the information database. At least one recommended parameter for the pharmacy order is determined based on the patient context data.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of electronic healthcare and records management, and more particularly, to a method and apparatus for determining pharmacy order parameters based on patient context data.

2. Description of the Related Art

Electronic medical record and practice management information systems store, retrieve, and deliver information to a health care entity. Typical providers of computerized systems for health care have tended to focus on specific aspects of the automation needs of health care providers, and thus, there are often multiple systems at a single health care institution including separate computer systems for billing and accounting, pharmacy, laboratory, in- or out-patient scheduling or tracking, medical records, appointments, and others. Some such different systems may be different software packages while others may involve entirely different computer hardware systems as well. In some cases, all systems in an organization are linked by a network, but such a network connection alone does not ensure that the systems can cooperatively exchange information among the divergent systems in the network. Often the different systems communicate by way of one or more software interfaces that must be custom built for each pair of systems which must communicate, even on the same network. It is also a trend in the health care industry in general that different organizations can cross-refer or partner in one or more areas or for certain types of patients, and thus different organizations with entirely different computer systems and networks find a need to share patient data.

Some healthcare entities employ electronic pharmacy components in their electronic healthcare systems to track medications. A physician places an order for a medication. The order is sent to a pharmacist who fills the order. The pharmacy order is delivered to a patient, and the patient's billing information is updated. Due to the interface difficulties described above, a pharmacy system may not have access to all of the patient data stored in other systems. For example, a pharmacy system used for entering and tracking orders for medications, may only have access to the identity information for a particular patient. Other patient data, such as the current diagnoses, treatments, laboratory values, clinical assessments, etc., may not be accessible through the interface between the medical records system and the pharmacy system.

Another limitation with current electronic pharmacy implementations lies in the level of detail that a physician must provide to place a pharmacy order. When a physician writes a medication order on paper, only the drug, dosage, and route are typically specified. For example, to place an order, a physician may order a 650 mg dose of acetaminophen to be administrated orally. However, for an electronic pharmacy system to process this order many other parameters need to be specified. The physician's order does not include sufficient data for the pharmacy system to complete this order. For example, after the physician specifies the medication, a pharmacist must select a package to dispense the medication. For example, the medication may come in different strength tablets, or in the case of liquid medications, different concentrations of the medication may be available.

Medications are typically identified by an NDC (National Drug Code). The NDC code of the prescribed medication is recorded in the patient record and used for dispensing and billing purposes. The NDC uniquely identifies the medication, strength, route, manufacturer, and package size. For any given medication, multiple manufacturers may exist, each providing a variety of strengths, forms (tablets, capsules, liquids, etc.), and package sizes (single dose blister packs, bulk bottles, etc.). Table 1 below lists some common strengths and forms of acetaminophen.

TABLE 1
Exemplary Drug Forms

Description
ACETAMINOPHEN 100 MG/ML PO SOLN
ACETAMINOPHEN 120 MG PR SUPP
ACETAMINOPHEN 120 MG/2.5 ML PO SOLN
ACETAMINOPHEN 130 MG/5 ML PO SOLN
ACETAMINOPHEN 160 MG PO CHEW
ACETAMINOPHEN 160 MG PO CPSP
ACETAMINOPHEN 160 MG PO TABS
ACETAMINOPHEN 160 MG PO TABS ACE160 [MPC
ACETAMINOP*]
ACETAMINOPHEN 160 MG/5 ML PO ELIX
ACETAMINOPHEN 160 MG/5 ML PO GEL
ACETAMINOPHEN 160 MG/5 ML PO LIQD
ACETAMINOPHEN 160 MG/5 ML PO SOLN
ACETAMINOPHEN 160 MG/5 ML PO SUSP
ACETAMINOPHEN 167 MG/5 ML PO LIQD
ACETAMINOPHEN 325 MG PO GREF
ACETAMINOPHEN 325 MG PO TABS
ACETAMINOPHEN 325 MG PR SUPP
ACETAMINOPHEN 325 MG/5 ML PO SOLN
ACETAMINOPHEN 500 MG PO CAPS
ACETAMINOPHEN 500 MG PO TABS
ACETAMINOPHEN 500 MG PO TABS
ACETAMINOPHEN 500 MG/5 ML PO LIQD
ACETAMINOPHEN 650 MG PO TBCR
ACETAMINOPHEN 650 MG PR SUPP
ACETAMINOPHEN 80 MG PO CHEW
ACETAMINOPHEN 80 MG PO CPSP
ACETAMINOPHEN 80 MG PO TBDP
ACETAMINOPHEN 80 MG PR SUPP
ACETAMINOPHEN 80 MG/0.8 ML PO SUSP

Each item on the list is available in multiple package sizes and from multiple manufacturers. A typical pharmacy will only stock a subset of the available products, reducing the list of choices but there will still be a number to choose from. Hence, to fill a given order, the pharmacist has a number of package options to contend with. Moreover, because the electronic pharmacy system may not have access to all relevant patient data, the pharmacist may not be able to identify patient specific needs in selecting the package to dispense. For example, a patient may be restricted to a liquid only diet. Not knowing this data, a pharmacist may dispense a tablet form incompatible with the patient's restrictions. Subsequently, the order may need to be corrected and re-filled, causing a delay in the administration of the medication.

Accordingly, what is needed is a method to more easily integrate an electronic pharmacy system into the normal workflow of a clinician ordering medications for a patient and a pharmacist filling the order. The present invention is directed to overcoming, or at least reducing the effects of, one or more of the problems set forth above.

### BRIEF SUMMARY OF THE INVENTION

The present inventors have recognized that a system may be constructed with a pharmacy module that accesses and uses patient context data stored in a patient record to recommend or determine one or more pharmacy order parameters, such as product, package, and or dose. Thus, pharmacy orders for a patient may incorporate the needs of the patient based on the information in the patient record, thus increasing the effectiveness of the pharmacy system.

One aspect of the present invention is seen in a health care information system including an information database and a pharmacy module. The information database is adapted to store a record for a patient including patient context data. The pharmacy module is adapted to receive a pharmacy order for the patient, retrieve the patient context data from the record in the information database, and determine at least one recommended parameter for the pharmacy order based on the patient context data.

Another aspect of the present invention is seen in a method for determining pharmacy order parameters in a health care information system. The method includes storing a record for a patient including patient context data. A pharmacy order is received for the patient. The patient context data is retrieved from the record in the information database. At least one recommended parameter for the pharmacy order is determined based on the patient context data.

Other objects, advantages and features of the present invention will become apparent from the following specification when taken in conjunction with the accompanying drawings.

### BRIEF DESCRIPTION OF THE SEVERAL VIEWS OF THE DRAWINGS

The invention may be understood by reference to the following description taken in conjunction with the accompanying drawings, in which like reference numerals identify like elements and in which:

FIG. 1 is a schematic illustration of a health care information system (HCIS) in accordance with one embodiment of the present invention;

FIG. 2 is a simplified diagram illustrating the interface between a pharmacy module in the HCIS of FIG. 1 and a patient record; and

FIG. 3 is an exemplary display generated by the pharmacy module of FIG. 2 showing a recommended pharmacy order parameter and rationale associated therewith.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

While the present invention may be embodied in any of several different forms, the present invention is described here with the understanding that the present disclosure is to be considered as setting forth an exemplification of the present invention that is not intended to limit the invention to the specific embodiment(s) illustrated. Nothing in this application is considered critical or essential to the present invention unless explicitly indicated as being “critical” or “essential.”

This invention is generally directed to an “intelligent” ordering and/or pharmacy system that combines medication information provided by a physician with patient context data included in a patient's electronic medical record to determine appropriate pharmacy order parameters. By automatically determining certain pharmacy order parameters, the physician is not hampered by having to specify some medication parameters which may not by nature require the exercise of medical judgment for their specification. The intelligent ordering/pharmacy system may be used to specify order parameters, such as, but not limited to, product parameters, package parameters, dose parameters, or combinations thereof. As used herein, the term pharmacy order refers to a medication order, a supply order, or an order for any other item that may be dispensed or managed by a pharmacist.

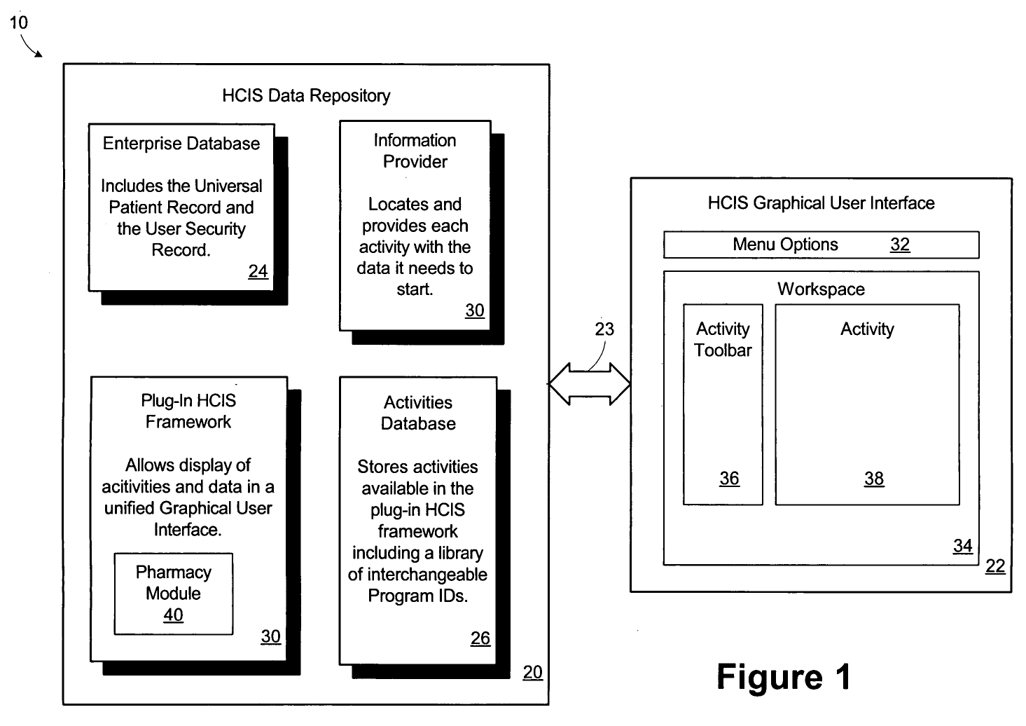

Referring to FIG. 1, an electronic Health Care Information System (HCIS) 10 is provided including a modular framework and a display in communication with the modular framework for providing a graphical user interface to a system user. The modular framework includes a plurality of activities, where each activity provides an aspect of patient care. Activities for providing aspects of patient care include, but are not limited to, activities used in the providing of health care to a patient (e.g., patient history activity, chart review activity, procedure ordering activity, pharmacy order activity, etc.) and activities used in the management of health care for a patient (e.g., registration, patient demographics, etc.). The graphical user interface is adaptable for displaying information corresponding to one or more of the activities, and includes a common menu format for communicating available operations in the graphical user interface, and common visual components for displaying information to a system user.

The modular framework allows additional activities to be added to the system without the difficulties associated with interfacing and configuring the activities to work with the HCIS and with each other. Further, the ease of integrating applications due to the modular framework results in a high rate of compliance with government regulations. The common menu structures and common visual components provided by the graphical user interface provide system users with a consistent interface for the HCIS 10, reducing the training requirements of system users who might otherwise be cross trained on multiple user interfaces. Additionally, the graphical user interface and modular framework allows system users to freely switch between activities available within the HCIS 10, even before completing a particular activity. The system users are therefore not forced into finishing a particular activity before gaining access to another activity, allowing for example, emergency situations to be addressed immediately without loss of information or work flow in an interrupted activity. Further, the graphical user interface and modular framework facilitates the combining of heterogeneous, but related, activities within a particular workflow or work space.

In some embodiments, a single information database may be provided for storing information related to the activities. Such an arrangement reduces, if not eliminates, data duplication between activities and avoids the difficulties associated with interfacing multiple databases having varying structure or format. Additionally, the single information database allows a common security record to be kept for system users, thus facilitating uniformity of security access for system users across all activities of the HCIS 10, increasing the ease of setting security requirements for new system users, and reducing the probability of granting mistaken security privileges, as security information for all activities need be entered but once. Further, the single information database and modular framework allows an alert system to be provided to warn system users where information entered in an activity conflicts with other information for a particular patient in the information database. Additionally, system users are provided the ability to configure the graphical user interface, giving the flexibility of tailoring the graphical user interface to offer functionality and information to better serve their specific needs. As described in greater detail below, the cross referencing of activities is useful in a pharmacy application in that it allows patient context data to be used to automatically determine pharmacy order parameters, thereby reducing the demands placed on the physician entering the pharmacy order.

As shown in FIG. 1, the HCIS 10 includes a Health Care Information System (“HCIS”) data repository 20 (i.e., a single information database) in communication with an HCIS graphical user interface 22 using a communications link 23. The data repository 20 supports a modular (“plug-in”) activity structure, in accordance with one embodiment of the invention. The HCIS data repository 20 includes an enterprise database 24 which stores information related to system users and patients, including a universal patient record having data collected for each patient and user security records defining security parameters for system users. Hence, the enterprise database 24 maintains a single data record per system user and patient. Further information regarding the universal patient record may be found in U.S. patent application Ser. No. 10/007,066, entitled “System And Method For Integration Of Health Care Records,” to Dvorak et al., attorney docket no. 29794/36697A, hereby incorporated by reference in its entirety.

Although the invention is illustrated in the context of an integrated healthcare system and a single information database, the application of the present invention is not so limited. Multiple information databases and/or multiple health care information systems may be employed and interfaced to accomplish the advantages described herein.

The HCIS data repository 20 further includes an activities database 26 which stores the activities available in the plug-in HCIS framework. The activities database 26 includes a library of interchangeable program identifications and data requirements for each activity which are used in building the graphical user interface 22. The HCIS data repository 20 further includes a modular (plug-in) framework 28 and an information provider 30, in communication with each other, and with the enterprise database 24 and the activities database 26. The plug-in framework utilizes information from the activities database 26 and is capable of composing and presenting each available activity to a system user in a unified graphical interface. Because the activities database 26 includes interchangeable program identifications, the HCIS graphical user interface 22 provides a unified look and common convention including a common menu format and common visual components. The information provider 30 locates and provides each activity to be initiated with the data it needs to start up, allowing each activity to be launched at any time without the necessity of obtaining data in each different context. Thus, when an activity is launched, the HCIS framework functionality 28 requests the information provider 30 to provide necessary data for launching the activity based on the data requirements provided by the activities database 26. For example, where the activity is patient-specific, therefore requiring a patient identification in order to open, the information provider 30 determines how to provide the patient identification in the current context (system user environment).

In one embodiment, the single data repository 20 is a server and the enterprise database 24 and the activities database 26 are embodied in a storage device, for example a hard drive, within the server. The functionality provided by the information provider 30 and the plug in framework 28 are programs running on a suitable processor within the server. The program identifications are program modules for forming specific functions which may be combined to form the functionality for a particular activity. The plug-in framework receives these program modules, or program address links for accessing the program modules, along with the data corresponding to the data requirements for the particular activity, and is able to provide the particular activity to the system user via the graphical user interface.

The HCIS graphical user interface 22 communicates with the data repository 20 via the communications link 23, allowing system users to access various activities provided by the HCIS system. The communication link 23 may represent the internet, a dedicated data bus, or any other means for communicating information between the HCIS data repository 20 and the HCIS graphical user interface 22, as would be appreciated by one skilled in the art. The HCIS graphical user interface 22 includes a menu 32 in a common menu format across activities and operations (workspaces), providing the system user with options for opening various workspaces, such as the workspace 34. The workspace 34 may allow handling of operations in a particular system user environment, for example handling patient admission and other patient encounters, scheduling, etc. as discussed below. The workspace 34 includes an activity toolbar 36 listing activities available to the system user within the particular workspace, where a particular activity selected by the system user is displayed in an activity display area 38. Activities may be nested within the work space 34 and are typically dynamically built according to information the information provider 30 delivers from the universal patient record and user security record of the enterprise database 24 and the activities database 26. Users may select tabs on the activity toolbar 36 to move freely between any combination of available activities without closing the workspace 38 or reentering information that is already available within the workspace context. Certain data combinations in the patient record may trigger alerts and requests for further data entry. These requests may automatically open new activities for the user, compelling compliance with enterprise-defined guidelines.

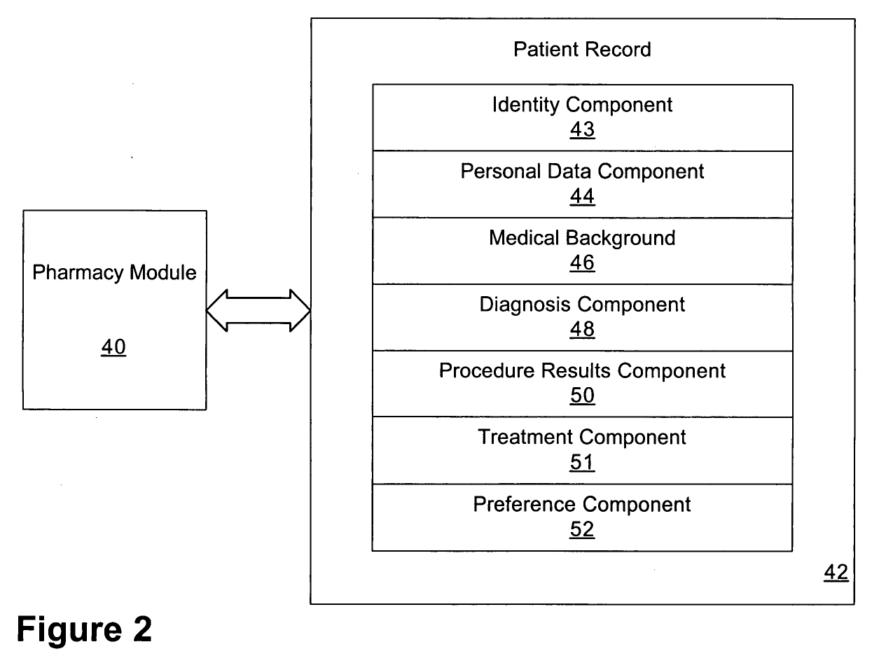

Turning now to FIG. 2, the discussion will now turn to the operation of the HCIS 10 for implementing pharmacy actions. The integration of function and data facilitated by the framework described above allows an intelligent pharmacy module 40 operating as a plug-in module on the HCIS 10 within the plug-in framework 28 to automatically determine pharmacy order parameters such, as product, package, or dose using patient context data available from the patient record 42. The pharmacy module 40 may initiate a pharmacy order (i.e., as an activity in the activity display area 38 of FIG. 1) with user specified order parameters and/or default order parameters predefined for various medications. Upon execution pharmacy orders are stored as activity records within the activities database 26 of FIG. 1. The term “pharmacy module,” as used herein, relates to a logical entity or set of program instructions that performs the functions described herein. Pharmacy functionality may reside in a single entity or may be distributed. For example, a pharmacy order, such as a medication order, may be initiated using an order entry module or system. The order entry system may determine one or more pharmacy order parameters based on patient context data. In such a case, the term pharmacy module encompasses this functionality residing in the order entry module.

Based on the patient context data, the pharmacy module 40 may determine that different parameters may be appropriate. In some cases, the pharmacy module 40 may modify the order parameters without requiring approval from the physician initiating the order. For example, the physician would not typically have to approve whether the medication is dispensed to the patient in tablet, gel cap, or chewable form, or if the medication is dispensed in individual dose blister packs or from a multi dose bottle. However, in some cases, authorization may be required to change an order parameter. For example, if the pharmacy module 40 recommends a different dose based on the patient context data, as described below, the approval may be warranted. The pharmacy module 40 may display the user specified or default parameters in conjunction with the recommended changes and associated rationale on which the recommendations are based. If the recommendation is based on a guideline, such as a manufacturer guideline, a link to the actual guideline may also be displayed to the physician. The physician may activate the link to display the full guideline or relevant portion thereof. The physician may then approve the order with the recommended parameters or ignore the recommendations and select the user specified or default parameters for the pharmacy order. Upon receiving approval, the pharmacy module 40 executes the pharmacy order and stores the order in the activities database 26.

The pharmacy module 40 may employ a plurality of rules specified for various medications. A rules builder system may be used to specify the particular rules. A pharmacy rule may be simple or complex (i.e., with nested logical operations). By way of example, the individual generating the rules may start by selecting a medication and then creating a logical expression that relates one or more patient context data items to various changes in the order. The rules builder may have a graphical user interface including drop down selections for the patient context data items and/or the logical connectors. A simple rule is shown below in which a liquid form is selected for a child based on age. In addition to recommending the form, the pharmacy module 40 also recommends a dose, and a volume (e.g., number of teaspoons) based on the patient's weight.
If (Med=acetaminophen and Patient_Age<10 and Patient_Age>2) then Rec_Form=160 mg/5 mL suspension, Rec_Dose=Patient_Weight*10 mg/kg, Admin_Volume=Dose/(160 mg/5 mL)

The dosing multiplier term, 10 mg/kg, represents an established dosing guideline. Medication manufacturers or other medical bodies typically publish such recommendations for dosing. These dosing recommendations may be based on age, weight, etc. Such published guidelines may be incorporated into the rules for the various medications. Of course more complicated rules may be generated using different logical operators or computations. For example, if the dose recommendation is based on weight or age ranges rather than just a multiple of weight, the rule might apply a nested or a multiple case structure.

As seen in FIG. 2, by way of example, the patient record 42 may include an identity component 43, a personal data component 44 (e.g., age, weight, height), a medical background component 46 (e.g., medication allergy, latex allergy, genomic profile), a diagnosis component 48 (i.e., listing past or current diagnoses), a procedure results component 50 (e.g., test results, x-rays, scans), a treatment component 51 (i.e., listing current or past treatments), and a preference component 52 (e.g., patient prefers capsules or gel caps to tablets, patient prefers liquid or chewable to tablet). As those of ordinary skill in the art will readily recognize, these components are only a small portion of the data that may be contained in the patient record 42. These components are selected as a subset of the patient record that may provide patient context data for making pharmacy order determinations.

In a first illustrative embodiment, the pharmacy module 40 employs patient context data in determining recommendations for the product to be specified in a pharmacy order. A rule for recommending a product may based on age, as described above with the rule that recommended a suspension for a child. For an infant, the pharmacy module 40 may instead recommend a 80 mg/0.8 mL liquid administered using a dropper. If the physician had ordered the suspension instead of the liquid, the pharmacy module 40 may recommend a product change to the liquid. The user may be presented with a screen showing the change and rationale for the change prior to executing the pharmacy order.

Another type of product rule may be based on medical history included in the diagnoses component 48, the procedure test result component 50, or the treatment component 51. If the patient is on a diet that is restricted to liquids, as specified in the treatment components 51, the pharmacy module 40 may recommend a liquid or elixir in lieu of a solid form. In another example, if the patient has been placed into a “nothing by mouth” (NBO) status, the pharmacy module 40 may switch the product to an injectable or rectal route and form. In yet another example, if the physician order a medication for osteoarthritis, such as Vioxx®, the pharmacy module 40 may check the patient record to determine if the patient has any conditions defined by the manufacturer that weigh against using the medication. If the patient has previously experienced asthma, hives, or allergic-type reactions after taking aspirin or other nonsteroidal anti-inflammatory drugs or if the patient has been diagnosed with pregnancy, ulcers, stomach bleeding, kidney problems, or liver problems, the manufacturer advises against using Vioxx®. Test results may be evaluated to determine conflicting conditions. For example, if the patient's creatinine level measured by a previous blood test is elevated, the patient may have a kidney problem. Pregnancy may also be identified by a previous blood test result or a lactation status indicator. If the pharmacy module 40 determines from the patient context data that the use of the specified medication might be advised against, it may change the order to reflect a different medication, such as tramadol hydrochloride or an opioid to treat the osteoarthritis condition.

Another type of product rule may be based on patient preference specified in the preference component 52. If the patient has a expressed a prefer an elixir over a gel cap due to a swallowing difficulty, or the patient may prefer a gel cap over a tablet. The pharmacy module 40 recognizes patient preferences and changes the product specified. The recommended change may or may not require approval prior to implementing, depending on the nature of the change.

In another illustrative embodiment, the pharmacy module 40 may implement packaging recommendations for the pharmacist based on patient context data. These recommendations may override previously entered parameter values or established default parameters for the medication specified in the pharmacy order. As with the product recommendations described above, the pharmacy module 40 may display the rationale for the recommendations along with the modified parameter. The original parameter may also be displayed.

One example of a package selection recommendation takes into account patient allergy information specified in the medical background component 46. For instance, the patient may have a latex allergy. Typically, intravenous antibiotics are provided in a flexible latex bag by default. The pharmacy module 40, based on the allergy information in the patient record, recommends an NDC code wherein the antibiotic is supplied in a glass container.

In another package selection example, a liquid medication to be administered intravenously is ordered. The pharmacy module 40 looks at the patient record, such as in the treatment component 51, to determine the size of the IV that has been ordered. A default package for the medication may be a 100 mL, but a 250 mL IV may have been ordered for the patient. The pharmacy module 40 changes the package size for the medication to match the package size of the IV so the proper medication concentration is provided.

A third area in which the pharmacy module 40 may implement order recommendations relates to dosing. The final decision remains with the physician in the application of their medical expertise. Typically, manufacturers provide dosing guidelines for use by physicians in prescribing treatments. In some cases, the dosing guidelines may be complicated and may require patient data, such as weight, age, lab test values, etc., for implementation. Hence, some medications require increased analysis by the physician and the use of default values may not be effective. Several examples of dosing recommendation incorporating patient context data are described below. The invention is not limited to these particular examples, but rather they are provided to illustrate how patient data can be combined with manufacturer guidelines to automatically recommend dosing parameters for consideration by a prescribing physician. Again, the pharmacy module 40 may display the recommended dose parameter and the rationale behind the recommendation for review and acceptance by the physician.

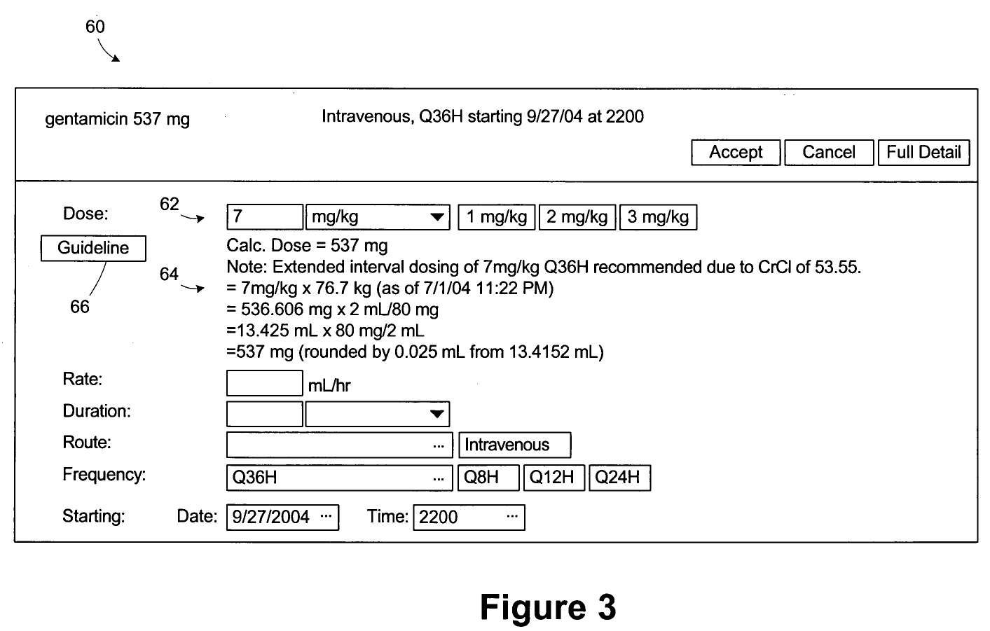

Aminoglycosides are antibiotics that are often administered into veins or muscle to treat serious bacterial infections. Some aminoglycosides are also used orally to treat intestinal infections or topically to treat eye infections. Doses for aminoglycoside orders are typically based on renal function (i.e., serum creatinine lab value) as well as patient information such as age, sex, etc. One particular aminoglycoside is gentamicin, which is typically administered using a low dose, continuous treatment. It has been determined that for patients with reduced kidney function, as evidenced by high creatinine levels, a high dose, short interval treatment is more effective than the typical low dose continuous treatment. When an order for gentamicin is entered, the pharmacy module 40 accesses the patient record to determine if a diagnosis of kidney problems or an elevated serum creatinine lab result is present. If evidence of kidney impairment is evident, the pharmacy module 40 recommends a high dose, short interval treatment and informs the physician about the change and rationale. FIG. 3 illustrates an exemplary screen display 60 that may be provided to the physician by the HCIS 10. The screen display 60 includes the recommended dose 62 and the dosing rationale 64. The physician may choose to implement the recommendation or to use a different dosing strategy based on medical judgment. The pharmacy module 40 may also display a link 66 to the fully detailed guideline used as a basis for the recommended dose. The physician may activate the link 66 to display the full guideline or relevant portion thereof for consideration. Similar links may also be provided for changes to the product or package selection parameters described above.

Doxorubicin is a medication used alone and in combination with other drugs for the treatment of tumors, including malignant lymphomas and leukemias. The dosing for doxorubicin may be adjusted based on hepatic function (serum biliribin lab value). Doses may also be adjusted based on a difference between the actual and adjusted weights for a patient.

The pharmacy module 40 may also perform functions to implement area under the curve (AUC) dosing of certain drugs, such as the chemotherapy agent, carboplatin. AUC dosing takes into account the level of drug in the patient's bloodstream and a target AUC in recommending the next dose.

Another dosing example involves examining multiple medications the patient has been prescribed to recommend a subsequent treatment. For example, the emetic potential of drugs (i.e., how likely a drug is to make the patient vomit) used in a regiment may be combined and used to recommend doses for antiemetics for the patient.

In general, the pharmacy module 40 conveniently provides additional data for the physician and/or pharmacist to consider in an efficient manner. Convenient access to this information improves the function of the healthcare entity and the effectiveness of the participants in implementing the patient's care. By recommending various pharmacy order parameters based on patient context data, the pharmacy module 40 helps tailor the pharmacy order to the particular needs of the patient and simplifies the task of filling the order for the pharmacist.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

I/We claim:

1. A health care information system, comprising:
an information database adapted to store a record for a patient including patient context data; and
a pharmacy module adapted to receive a pharmacy order for the patient, retrieve the patient context data from the record in the information database, and determine at least one recommended parameter for the pharmacy order based on the patient context data.

2. The system of claim 1, wherein the recommended parameter comprises at least one of a product parameter, a package parameter, and a dose parameter for the pharmacy order.

3. The system of claim 1, wherein the record comprises at least one of a personal data component, a medical background component, a diagnosis component, a procedure results component, a treatment component, and a preference component.

4. The system of claim 1, wherein the pharmacy order includes at least one specified parameter, the recommended parameter comprises a modification to the specified parameter, and the pharmacy module is adapted to display the specified parameter and the recommended parameter.

5. The system of claim 4, wherein the pharmacy module is further adapted to display rationale data for modifying the specified parameter.

6. The system of claim 4, wherein the specified parameter comprises at least one of a default parameter and a user-specified parameter.

7. The system of claim 1, wherein the pharmacy module is adapted to request approval for the recommended parameter and place the pharmacy order responsive to receiving the approval.

8. The system of claim 1, wherein the patient context data comprises at least one of an age and a weight.

9. The system of claim 1, wherein the patient context data comprises at least one of a test result parameter, a diagnosis parameter, a medical history parameter, an allergy parameter, and a preference parameter.

10. The system of claim 1, wherein the patient context data comprises age data, and the recommended parameter comprises a product parameter.

11. The system of claim 10, wherein the product parameter comprises a concentration parameter.

12. The system of claim 10, wherein the product parameter comprises a product form parameter.

13. The system of claim 1, wherein the patient context data comprises patient preference data, and the recommended parameter comprises a product form parameter.

14. The system of claim 1, wherein the patient context data comprises a diet restriction parameter, and the recommended parameter comprises a product form parameter.

15. The system of claim 1, wherein the patient context data comprises patient preference data, and the recommended parameter comprises a product form parameter.

16. The system of claim 1, wherein the patient context data comprises patient allergy data, and the recommended parameter comprises a product package parameter.

17. The system of claim 1, wherein the patient context data comprises at least one of diagnosis data and lab result data, the pharmacy order includes a medication, and the pharmacy module is further adapted to determine an alternate medication as the recommended parameter based on the patient context data.

18. The system of claim 1, wherein the patient context data comprises a volume of an intravenous fluid container ordered for the patient, and the recommended parameter comprises a package size for the medication having a concentration consistent with the volume of the intravenous fluid container.

19. The system of claim 1, wherein the patient context data comprises at least one of diagnosis data and lab result data, and the recommended parameter comprises a product dose parameter.

20. The system of claim 1, wherein the patient context data comprises at least one of age and weight, and the recommended parameter comprises a product dose parameter.

21. The system of claim 1, wherein the patient context data includes weight and an adjusted weight, and the pharmacy module is adapted to determine a product dose parameter as the recommended parameter based on the difference between the weight and the adjusted weight.

22. The system of claim 1, wherein the patient context data comprises prior medication dosing data, and the pharmacy module is adapted to determine a current medication level for the patient based on the prior medication dosing data and determine a dose parameter for a subsequent administration of a medication as the recommended parameter based on the current medication level.

23. The system of claim 1, wherein the patient context data comprises prior medication dosing data, and the pharmacy module is adapted to determine a cumulative effect based on the prior medication dosing data and determine a dose parameter for a subsequent administration of a medication as the recommended parameter based on the determined cumulative effect.

24. A method for determining pharmacy order parameters in a health care information system, comprising:
storing a record for a patient including patient context data;
receiving a pharmacy order for the patient;
retrieving the patient context data from the record in the information database; and
determining at least one recommended parameter for the pharmacy order based on the patient context data.

25. The method of claim 24, wherein determining the recommended parameter comprises determining at least one of a product parameter, a package parameter, and a dose parameter for the pharmacy order.

26. The method of claim 24, wherein storing the record comprises storing at least one of a personal data component, a medical background component, a diagnosis component, a procedure results component, a treatment component, and a preference component.

27. The method of claim 24, wherein the pharmacy order includes at least one specified parameter, and the method further comprises:
modifying the specified parameter to determine the recommended parameter; and
displaying the specified parameter and the recommended parameter.

28. The method of claim 27, further comprising displaying rationale data for modifying the specified parameter.

29. The method of claim 27, further comprising receiving the specified parameter, wherein the specified parameter comprises at least one of a default parameter and a user-specified parameter.

30. The method of claim 24, further comprising:
requesting approval for the recommended parameter; and
placing the pharmacy order responsive to receiving the approval.

31. The method of claim 24, wherein retrieving the patient context data retrieving comprises at least one of an age and a weight.

32. The method of claim 24, wherein retrieving the patient context data comprises retrieving at least one of a test result parameter, a diagnosis parameter, a medical history parameter, an allergy parameter, and a preference parameter.

33. The method of claim 24, wherein retrieving the patient context data comprises retrieving age data, and determining the recommended parameter comprises determining a product parameter.

34. The method of claim 33, wherein determining the product parameter comprises determining a concentration parameter.

35. The method of claim 33, wherein determining the product parameter comprises determining a product form parameter.

36. The method of claim 24, wherein retrieving the patient context data comprises retrieving patient preference data, and determining the recommended parameter comprises determining a product form parameter.

37. The method of claim 24, wherein retrieving the patient context data comprises retrieving a diet restriction parameter, and determining the recommended parameter comprises determining a product form parameter.

38. The method of claim 24, wherein retrieving the patient context data comprises retrieving patient preference data, and determining the recommended parameter comprises determining a product form parameter.

39. The method of claim 24, wherein retrieving the patient context data comprises retrieving patient allergy data, and determining the recommended parameter comprises determining a product package parameter.

40. The method of claim 24, wherein the pharmacy order includes a medication, retrieving the patient context data comprises retrieving at least one of diagnosis data and lab result data, and determining the recommended parameter comprises determining an alternate medication as the recommended parameter based on the patient context data.

41. The method of claim 24, wherein retrieving the patient context data comprises retrieving a volume of an intravenous fluid container ordered for the patient, and determining the recommended parameter comprises determining a package size for the medication having a concentration consistent with the volume of the intravenous fluid container.

42. The method of claim 24, wherein retrieving the patient context data comprises retrieving at least one of diagnosis data and lab result data, and determining the recommended parameter comprises determining a product dose parameter.

43. The method of claim 24, wherein retrieving the patient context data comprises retrieving at least one of age and weight, and the determining recommended parameter comprises determining a product dose parameter.

44. The method of claim 24, wherein retrieving the patient context data includes retrieving weight and an adjusted weight, and determining the recommended parameter comprises determining a product dose parameter based on the difference between the weight and the adjusted weight.

45. The method of claim 24, wherein retrieving the patient context data comprises retrieving prior medication dosing data, and determining the recommended parameter further comprises:
determining a current medication level for the patient based on the prior medication dosing data; and
determining a dose parameter for a subsequent administration of a medication as the recommended parameter based on the current medication level.

46. The method of claim 24, wherein retrieving the patient context data comprises retrieving prior medication dosing data, and determining the recommended parameter comprises:
determining a cumulative effect based on the prior medication dosing data; and
determining a dose parameter for a subsequent administration of a medication as the recommended parameter based on the determined cumulative effect.

47. A health care information system, comprising:
means for storing a record for a patient including patient context data;
means for receiving a pharmacy order for the patient;
means for retrieving the patient context data from the record in the information database; and
means for determining at least one recommended parameter for the pharmacy order based on the patient context data.
